(19) United States
(12) Patent Application Publication
(10) Pub. No.: US 2023/0103408 A1
(43) Pub. Date: Apr. 6, 2023

(54) TURNING METHOD FOR WORKPIECE, MACHINE TOOL, AND NON-TRANSITORY COMPUTER-READABLE STORAGE MEDIUM STORING MACHINING PROGRAM

(71) Applicant: OKUMA CORPORATION, Niwa-Gun (JP)

(72) Inventor: Kazunori FUJISE, Niwa-Gun (JP)

(73) Assignee: OKUMA CORPORATION, Niwa-Gun (JP)

(21) Appl. No.: 17/935,169

(22) Filed: Sep. 26, 2022

(30) Foreign Application Priority Data
Oct. 1, 2021 (JP) 2021-162997

(51) Int. Cl. B23B 1/00; B23B 11/00

(52) U.S. Cl. CPC B23B 1/00; B23B 11/00

(57) ABSTRACT

A turning method for performing a turning on a workpiece in a machine tool includes: feeding a tool in a rotation axis direction and/or a radial direction of a workpiece while rotating the workpiece, the tool including an insert having a side cutting edge, the side cutting edge including a straight line portion; and feeding the tool in the rotation axis direction and the radial direction and in a predetermined inclined direction that is non-parallel to a final machining surface of the workpiece, so as to perform a turning such that a cutting edge angle as an angle formed by the straight line portion of the side cutting edge and the inclined direction becomes less than 90°.

### CROSS REFERENCE TO RELATED APPLICATION

This application claims the benefit of Japanese Patent Application Number 2021-1162997 filed on Oct. 1, 2021, the entirety of which is incorporated by reference.

### FIELD OF THE INVENTION

The disclosure relates to a method for performing a turning on a workpiece by a machine tool, a machine tool, and a non-transitory computer-readable storage medium storing a machining program configured to execute the method.

### BACKGROUND OF THE INVENTION

When a turning is performed on a workpiece of SUS, titanium alloy, heat-resistant alloy, or the like, there is a likelihood that a tool life is shortened due to generation of boundary wear. As a countermeasure, it is known that it is effective to decrease a cutting edge angle of an insert, for example, to less than 90°, as disclosed in the Japan Society for Precision Engineering. Text of the 342nd Workshop [Demand will increase! A la carte of advanced processing technology for highly intractable materials such as superalloy, ceramics, and composite materials] Juyo ga takamaru! Nankakouzai (chougoukin, seramikkusu, fukugouzairyou) no senshin kakou gijutsu arakaruto (in Japanese): [High-speed and high-performance cutting tool for aircraft jet engine components] Koukuuki jetto enjin buhin no kousoku, kouseinou sessaku kougu (in Japanese). Jun. 10, 2010: Pages 6 to 7.

However, in a case where a turning is performed on a workpiece having a step shape including a small diameter portion and a large diameter portion, a cutting residue is generated when a cutting edge angle is small. This is because the small cutting edge angle causes interference of the insert with the workpiece near an end surface of the large diameter portion that connects to the small diameter portion. Accordingly, the cutting residue should be machined by another tool, the number of tools increases, and a cutting time becomes longer.

Therefore, in JP H3-19701 A and JP 2003-71601 A, machining methods that suppress the boundary wear by changing a feeding amount of a tool to move a boundary are disclosed. JP 2006-68874 A discloses a machining method that allows continuous machining by turning a tool main spindle equipped with a button tool around a B-axis to sequentially change a cutting edge position.

However, with the machining methods of JP H3-19701 A and JP 2003-71601 A, the boundary wear of a side cutting edge cannot be suppressed because a cut amount becomes constant. In the case of the machining method of JP 2006-68874 A, a mechanism for turning the tool around the B-axis is required and the machine tool becomes expensive.

Therefore, it is an object of the disclosure to provide a turning method for a workpiece, a machine tool, and a non-transitory computer-readable storage medium storing a machining program that can suppress boundary wear even with a side cutting edge with an inexpensive configuration.

### SUMMARY OF THE INVENTION

In order to achieve the above-described object, a first configuration of the disclosure is a turning method for performing a turning on a workpiece in a machine tool. The turning method includes: feeding a tool in a rotation axis direction and/or a radial direction of a workpiece while rotating the workpiece, the tool including an insert having a side cutting edge, the side cutting edge including a straight line portion; and feeding the tool in the rotation axis direction and the radial direction and in a predetermined inclined direction that is non-parallel to a final machining surface of the workpiece, so as to perform a turning such that a cutting edge angle as an angle formed by the straight line portion of the side cutting edge and the inclined direction becomes less than 90°.

In another aspect of the first configuration of the disclosure, which is in the above configuration, the tool includes the insert in which an angle formed by a direction parallel to or a direction perpendicular to the rotation axis direction and the straight line portion of the side cutting edge is a right angle or an obtuse angle.

In another aspect of the first configuration of the disclosure, which is in the above configuration, an angle of the inclined direction is determined from a shape of the final machining surface of the workpiece and a shape of the insert.

Another aspect of the first configuration of the disclosure, which is in the above configuration, further includes causing the machine tool to automatically generate a machining program based on the determined angle of the inclined direction to perform a turning in accordance with the machining program.

In another aspect of the first configuration of the disclosure, which is in the above configuration, a part of a sequence of machining processes from a machining start to a machining end includes the feeding in the inclined direction.

In order to achieve the above-described object, a second configuration of the disclosure is a machine tool configured to execute the turning method for a workpiece of any one of the first configuration.

In order to achieve the above-described object, a third configuration of the disclosure is a non-transitory computer-readable storage medium storing a machining program for causing a control device of a machine tool to execute the turning method for a workpiece of the first configuration. The machine tool is configured to perform a turning on a workpiece by feeding a tool in a rotation axis direction and/or a radial direction of a workpiece while rotating the workpiece. The tool includes an insert having a side cutting edge. The side cutting edge includes a straight line portion.

With the disclosure, by spuriously decreasing the cutting edge angle by inclined machining, boundary wear can be suppressed even with the side cutting edge. Additionally, since a turning mechanism and the like around a rotation axis of the tool is not required, the boundary wear can be suppressed with an inexpensive configuration.

### BRIEF DESCRIPTION OF THE DRAWINGS

FIG. 1 is an explanatory view illustrating a configuration of a turning by a CNC lathe.

FIGS. 2A and 2B are explanatory views of a turning method.

FIGS. 3A and 3B are enlarged views of an inclined machining part.

FIG. 4 is a flowchart of a machining program generation method.

FIG. 5 is an explanatory view of a turning method when a workpiece shape is different.

FIG. 6 is an explanatory view of a turning method when a workpiece shape is different.

FIG. 7 is an explanatory view of a turning method when an insert shape is different.

FIG. 8 is an explanatory view illustrating an example of a conventional turning method.

### DETAILED DESCRIPTION OF THE INVENTION

The following describes an embodiment of the disclosure based on the drawings.

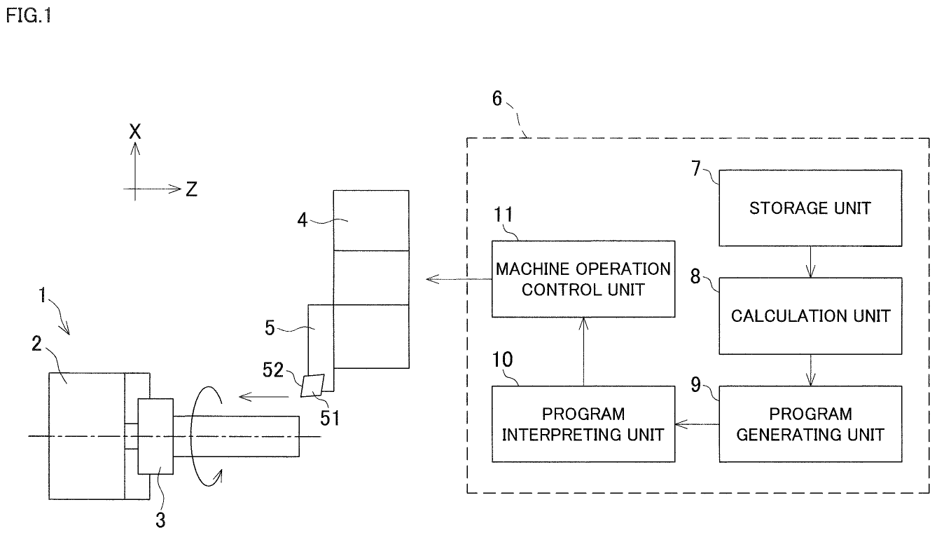

FIG. 1 is a schematic diagram illustrating a configuration of a turning by a CNC lathe as an example of a machine tool. A CNC lathe 1 has a chuck 2 for holding a workpiece 3 to a main spindle that rotatably drives. A tool 5, such as a single point tool, including an insert 51 at a distal end is secured to a tool post 4 and controlled by an NC device 6. The insert 51 has a diamond shape in which a side cutting edge 52, which is a main cutting edge, is in a straight line.

The NC device 6 has a storage unit 7, a calculation unit 8, a program generating unit 9, a program interpreting unit 10, and a machine operation control unit 11. The storage unit 7 stores a product shape and a tool shape. The calculation unit 8 calculates an angle of inclined machining from the product shape and the tool shape. The program generating unit 9 generates a machining program. The program interpreting unit 10 interprets the machining program. The machine operation control unit 11 controls a machine.

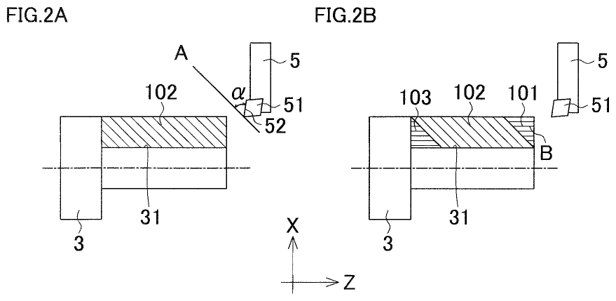

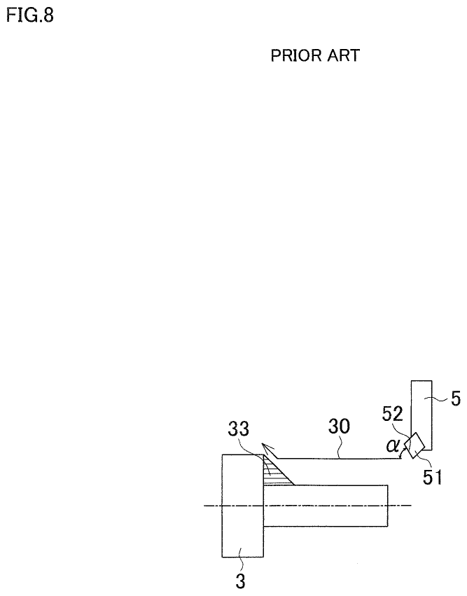

FIGS. 2A and 2B are schematic diagrams of a turning method for the workpiece 3. To suppress the boundary wear of the side cutting edge 52 in the turning, the tool 5 as illustrated in FIG. 8 is used and machining is performed by feeding the tool 5 like a cutting path 30. The tool 5 includes the insert 51 that has a small (acute) cutting edge angle α, which is an angle formed by the side cutting edge 52 and a rotation axis direction of the workpiece 3. However, when the workpiece 3 has a step shape, a cutting residue 33 as illustrated in FIG. 8 is generated. Therefore, the cutting residue 33 should be machined by another tool in which the cutting edge angle α becomes a right angle or an obtuse angle. Accordingly, the number of tools is increased and a cutting time is increased.

Therefore, as illustrated in FIG. 2A, in a machined portion 102, the machining is performed by feeding the tool 5 in a direction A inclined with respect to a final machining surface 31 of the workpiece 3. The feed may be a reciprocating motion or a repetitive motion in one direction. By the inclined machining, the cutting edge angle α with respect to the direction A spuriously decreases to less than 90°, allowing suppression of the boundary wear.

In this case, as illustrated in FIG. 2A, the inclined machining may be performed on the whole region of the machined portion 102. Additionally, as illustrated in FIG. 2B, among a sequence of machining processes, a middle portion of the machined portion 102 may be machined by the inclined machining, and a machined portion 101 at the start and a machined portion 103 at the end, which are both ends of the machined portion 102, may be machined by parallel machining. The parallel machining is a machining that is to cut in a direction B parallel to the final machining surface 31 of the workpiece 3.

Thus, the feeding in an inclined direction is included in a part of the sequence of machining processes from the machining start to the machining end. Then, the inclined machining and the parallel machining are used properly, allowing well-balanced machining taking into consideration both the cutting time and the tool life by the boundary wear. In particular, since the turning can be performed also on the machined portion 103 at the end using the same tool 5, the machining can be completed with the one tool 5 without generating cutting residue.

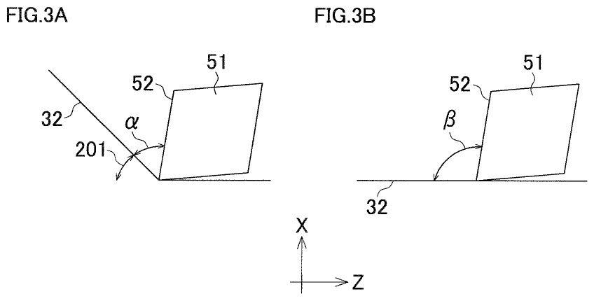

FIGS. 3A and 3B are enlarged views of the inclined machining. When the parallel machining is performed on a machining surface 32 before the final machining in a Z-axis direction with the insert 51 having a large cutting edge angle β as illustrated in FIG. 3B, the cutting edge angle β becomes 90° or more and boundary wear is generated. However, the inclined machining is performed so as to be the machining surface 32 inclined at an inclination angle 201, which is an angle in the inclined direction, from the Z-axis direction as illustrated in FIG. 3A. Thus, the cutting edge angle α with respect to the machining surface 32 spuriously becomes less than 90°. Accordingly, the boundary wear is suppressed.

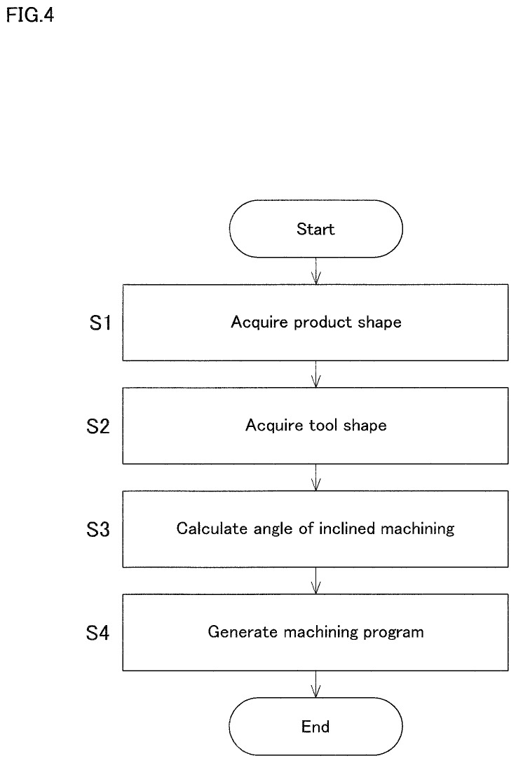

FIG. 4 is a flowchart pertaining to a generation method of a machining program by the NC device 6. In Step 1, the product shape is acquired with, such as, an input by an operator and stored in the storage unit 7. Step is hereinafter referred to as “S.” In S2, the tool shape, which is a shape of the insert 51, is acquired with, such as, an input by the operator and stored in the storage unit 7. In S3, based on the data acquired in S1 and S2, the calculation unit 8 calculates an angle of the inclined machining, that is, the inclination angle 201. In S4, based on the inclination angle 201 calculated in S3, the program generating unit 9 generates the machining program.

Accordingly, the machine operation control unit 11 controls the tool 5 based on the machining program interpreted by the program interpreting unit 10 and performs the turning on the workpiece 3.

By thus determining the inclination angle 201 from the shape of a final machining surface of a workpiece and the shape of the insert 51 as a tool, labor to determine the inclination angle 201 by the operator can be reduced.

Additionally, by automatically generating the machining program based on the determined inclination angle 201 and performing the turning in accordance with the machining program, time and effort to spend for generating the machining program can be reduced.

Thus, the turning method, the CNC lathe 1, and the machining program of the above-described configuration feed the tool 5 in the rotation axis direction and a radial direction of the workpiece 3 and in a predetermined inclined direction A that is non-parallel to the final machining surface 31 of the workpiece 3. Thus, the turning is performed such that the cutting edge angle α as the angle formed by a straight line portion of the side cutting edge 52 and the inclined direction A becomes less than 90°.

With the configuration, by spuriously decreasing the cutting edge angle α by the inclined machining, the boundary wear can be suppressed even with the side cutting edge 52. Additionally, since a turning mechanism or the like around the rotation axis of the tool is not required, the boundary wear can be suppressed with an inexpensive configuration.

In particular, the inclined machining is performed using the tool 5 including the insert 51 in which the cutting edge angle β becomes an obtuse angle or a right angle with respect to a direction parallel to the rotation axis direction of a workpiece. Thus, any cutting residue is not generated at a perpendicular end surface portion of the large diameter portion of the workpiece, and the turning can be performed with the one tool 5. Accordingly, increase in the number of tools and period required for tool exchange can be reduced.

While a workpiece in which a final machining surface becomes parallel to a rotation axis direction is illustrated in the above-described configuration, the disclosure is not limited to this.

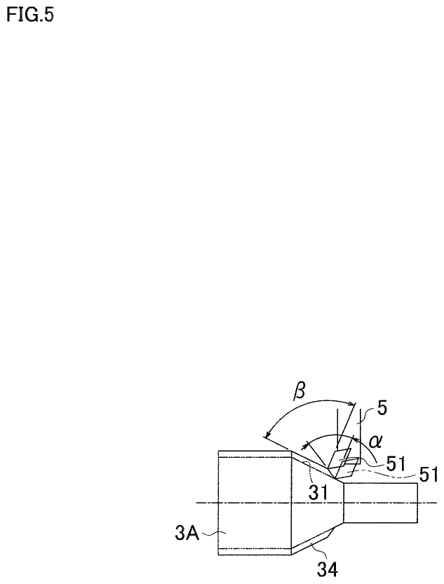

For example, as illustrated in FIG. 5, even on a workpiece 3A having a tapered portion 34 inclined to the rotation axis direction, the inclined machining is performed on the final machining surface 31 indicated by a two-dot chain line. Then, the cutting edge angle α becomes smaller than the cutting edge angle β for a case of machining in parallel with the final machining surface 31.

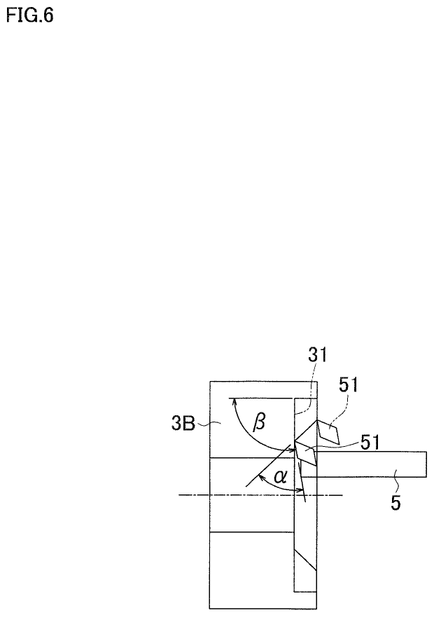

Additionally, as illustrated in FIG. 6, on a workpiece 3B in which the final machining surface 31 is perpendicular to the rotation axis direction, the inclined machining is performed on the final machining surface 31 even when the tool 5 is mounted in parallel with the rotation axis direction of the workpiece 3B to feed. Then, the cutting edge angle α becomes smaller than the cutting edge angle β for the case of machining in parallel with the final machining surface 31.

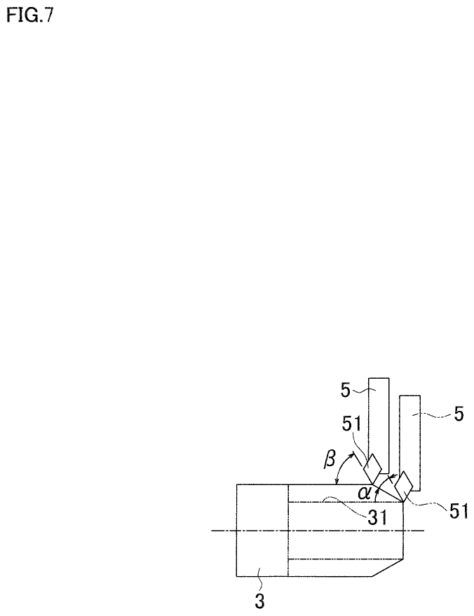

Meanwhile, in the above-described configuration, an insert in which a cutting edge angle becomes an obtuse angle in a case of feeding a tool in parallel with the rotation axis direction of the workpiece is illustrated. However, as illustrated in FIG. 7, the inclined machining is performed on the final machining surface 31 even when the tool 5 including the insert 51 in which the cutting edge angle β becomes an acute angle even by feeding in parallel with the final machining surface 31 of the workpiece 3. Then, the cutting edge angle α becomes smaller than the cutting edge angle β for a case of machining in parallel with the final machining surface 31.

Additionally, in the above-described configuration, the machining program including the inclined machining is automatically generated. However, the inclination angle at which the boundary wear is less likely to be generated may be preliminary obtained for each tool shape by an experiment or the like, and the inclination angle value may be employed each time.

Furthermore, when the inclination angle is calculated, an operator may determine the inclination angle by including parameters of cutting conditions, such as cutting time and the number of machining cycles, and presenting a calculation result of the cutting time and the tool life caused by the boundary wear to the operator.

Besides, the machine tool is not limited to the CNC lathe and may be a multitasking machine and the like that allows the turning. The shape of the insert is not limited to a diamond shape described in the above-described configuration and may be another shape, such as a triangular shape.

It is explicitly stated that all features disclosed in the description and/or the claims are intended to be disclosed separately and independently from each other for the purpose of original disclosure as well as for the purpose of restricting the claimed invention independent of the composition of the features in the embodiments and/or the claims. It is explicitly stated that all value ranges or indications of groups of entities disclose every possible intermediate value or intermediate entity for the purpose of original disclosure as well as for the purpose of restricting the claimed invention, in particular as limits of value ranges.

1. A turning method for performing a turning on a workpiece in a machine tool, the turning method comprising:
feeding a tool in a rotation axis direction and/or a radial direction of a workpiece while rotating the workpiece, the tool including an insert having a side cutting edge, the side cutting edge including a straight line portion; and
feeding the tool in the rotation axis direction and the radial direction and in a predetermined inclined direction that is non-parallel to a final machining surface of the workpiece, so as to perform a turning such that a cutting edge angle as an angle formed by the straight line portion of the side cutting edge and the inclined direction becomes less than 90°.

2. The turning method for a workpiece according to claim 1, wherein
the tool includes the insert in which an angle formed by a direction parallel to or a direction perpendicular to the rotation axis direction and the straight line portion of the side cutting edge is a right angle or an obtuse angle.

3. The turning method for a workpiece according to claim 1, wherein
an angle of the inclined direction is determined from a shape of the final machining surface of the workpiece and a shape of the insert.

4. The turning method for a workpiece according to claim 3, comprising
causing the machine tool to automatically generate a machining program based on the determined angle of the inclined direction to perform a turning in accordance with the machining program.

5. The turning method for a workpiece according to claim 1, wherein
a part of a sequence of machining processes from a machining start to a machining end includes the feeding in the inclined direction.

6. A machine tool configured to execute the turning method for a workpiece according to claim 1.

7. A non-transitory computer-readable storage medium storing a machining program for causing a control device of a machine tool to execute the turning method for a workpiece according to claim 1, wherein
the machine tool is configured to perform a turning on a workpiece by feeding a tool in a rotation axis direction and/or a radial direction of the workpiece while rotating the workpiece, the tool including an insert having a side cutting edge, the side cutting edge including a straight line portion.
